(19) United States
(12) Patent Application Publication
(10) Pub. No.: US 2012/0037151 A1
(43) Pub. Date: Feb. 16, 2012

(54) SOLAR COLLECTOR

(76) Inventors: Paul Thomas McEntee, Belfast (GB); Richard Pelan, County Down (GB); Christopher McCracken, County Down (GB); Patrick Robert Davis, County (GB)

(21) Appl. No.: 13/266,184

(22) PCT Filed: Apr. 27, 2010
(86) PCT No.: PCT/IE10/00031

§ 371 Date: Oct. 25, 2011

(30) Foreign Application Priority Data
Apr. 27, 2009 (IE) 2009/0334

(51) Int. Cl. F24J 2/05; F16L 39/00

(52) U.S. Cl. 126/652; 285/123.3

(57) ABSTRACT

A solar collector assembly comprises a solar absorbing tube (1) having an evacuated radiation-transparent enclosure (8); a radiation absorber (10) within the tube (1), an elongate outer conduit (11) for a heat transfer medium extending through the tube (1), an inner conduit (12) extending through the outer conduit (11), and a manifold (2). The outer conduit (11) has an end region (5) extending into the manifold (2) so that passageway (13) defined between the outer conduit (11) and the inner conduit (12) is in fluid communication with the cold fluid passageway of the manifold (2). The inner conduit (12) extends beyond the end region (5) of the outer conduit (11) into the heated fluid passageway of the manifold (2). The solar collector also comprises a clip (20) for retaining the inner conduit (12) in spaced-apart relation to the end region (5) of the outer conduit (11). The clip (20) comprises a generally circular base (24) which engages with the inner surface of the end region (5) of the outer conduit (11). The base (24) has a plurality of inwardly extending teeth (23) which engage with the outer wall of the inner conduit (12). The teeth (23) are at least partially resilient and are spaced-apart to allow heat exchange fluid to pass between the teeth (23).

The present invention relates to a solar collector for converting solar radiation into heat and to transfer the latter with the maximum possible efficiency to a fluid heat transferring means (e.g. water or air) whereby the heat can be utilised in a domestic or industrial application, for example to heat a domestic hot water or central heating system.

A solar collector typically comprises a number of elongate tubes containing a radiation absorbing plate for absorbing solar radiation in contact with a pipe through which the fluid to be heated can be passed or within which is contained a working fluid for transferring heat to the fluid to be heated. The radiation absorbing plate and at least a portion of the pipe are enclosed within an evacuated radiation transparent enclosure to prevent heat loss.

In one type of solar collector, known as the direct flow type, the fluid to be heated flows through the pipe in contact with the plate for direct conduction of heat between the plate and the fluid. In one type of direct flow collector, the fluid to be heated flows in a concentric manner through the elongate tube. The solar collector further comprises a heat collection manifold containing a fluid to be heated and having at least one solar tube receiving aperture therein for insertion of an end of each elongate tube to enable the fluid to be heated to pass into and out of the pipe of each elongate tube. The manifold is typically provided with inlet and outlet connections. In one case the input fluid to be heated passes along the outer concentric chamber to a distal end of the elongate tube and returns along the inner concentric flow path where it outputs into the manifold flow chamber. In another case, the input flow passes along the inner concentric chamber to a distal end where it returns along the outer concentric flow path where it outputs into the manifold flow chamber.

There is a need for a solar collector in which the separate elongate tubes and the heat collection manifold are readily assembled on site and capable of taking up the tolerances required without risk of damage or leakages. In addition, it is necessary that the component parts be easily replaceable.

### STATEMENTS OF INVENTION

According to the invention there is provided a solar collector assembly comprising:
a solar absorbing tube having an evacuated radiation-transparent enclosure;
a radiation absorber within the tube;
an elongate outer conduit for a heat transfer medium extending through the tube and being in thermal contact with the radiation absorber;
an inner conduit extending through the outer conduit and being positioned within the outer elongate conduit to define an elongate internal flow passage for the flow of heat transfer medium;
a manifold having a heated fluid passageway and a cold fluid passageway;
the outer conduit having an end region extending into the manifold so that the passageway defined between the outer conduit and the inner conduit is in fluid communication with the cold fluid passageway of the manifold;
the inner conduit extending beyond the end region of the outer conduit into the heated fluid passageway of the manifold; and
a clip for retaining the inner conduit in spaced-apart relation to the end region of the outer conduit, the clip comprising a generally circular base which engages with the inner surface of the end region of the outer conduit the base having a plurality of inwardly extending teeth which engage with the outer wall of the inner conduit, the teeth being at least partially resilient and being spaced-apart to allow heat exchange fluid to pass between the teeth.

The invention also provides a clip for retaining the inner conduit in spaced-apart relation to the end region of the outer conduit, the clip comprising a generally circular base which engages with the inner surface of the end region of the outer conduit the base having a plurality of inwardly extending teeth which engage with the outer wall of the inner conduit, the teeth being at least partially resilient and being spaced-apart to allow heat exchange fluid to pass between the teeth.

In one embodiment the teeth are inclined inwardly with respect to the circumference of the base.

In a preferred embodiment the base has a longitudinally extending outer wall. The outer wall is preferably of generally cylindrical shape.

In one embodiment the teeth extend inwardly at one end of the outer wall.

In one case there are three equi-spaced-apart teeth. In another case there are four equi-spaced-apart teeth.

In one embodiment the thickness of at least some of the teeth is reduced at the inner free end thereof.

The clip may be of stainless steel material.

In the invention, the inner concentric chamber is held in its concentric position within the outer concentric chamber by a resilient star-clip. The resilient star-clip is further provided with a plurality of retaining teeth or tags that are dimensioned such that they provide both a strong interference fit with the inner concentric chamber and occlusions such that the star-clip additionally provides a plurality of flow paths without restriction to the heat-transfer fluid.

Additionally, the resilient star-clip is provided with a peripheral wall that provides additional structural support to the softer bellow material into which the clip is inserted.

The base of the clip engages with the inner surface of the end region of the outer conduit to ensure that any movement of the inner pipe in the longitudinal direction is prevented.

### BRIEF DESCRIPTION OF THE DRAWINGS

The invention will be more clearly understood from the following description of an embodiment thereof, given by way of example only, with reference to the accompanying drawings, in which:

FIG. 1 is a perspective sectional view of a tubular solar collector;

FIG. 2 is a cross-section on the line II-II of FIG. 1 of a solar collector tube of the direct flow type;

FIG. 3 is an exploded perspective view showing a retaining clip and an inner conduit (flow pipe);

FIG. 4 is a perspective view showing the clip attached to the inner flow pipe;

FIGS. 5 to 8 are enlarged perspective views of the clip;

FIG. 9 is an end-on planar view of the clip;

FIG. 10 is an end-on planar view of the clip and inner flow pipe assembly highlighting the fluid flow conduits through the assembly;

FIG. 11 is an exploded perspective view of the end-fitting of a solar collector tube of the direct flow type utilising the clip;

FIG. 12 is an exploded perspective view of the end-fitting of a solar collector tube of the direct flow type showing the clip attached to the inner chamber elongate tube;

FIG. 13 is a perspective view of the end-fitting of a solar collector tube of the direct flow type utilising the clip;

FIG. 14 is a planar cross-sectional view of the clip and the inner flow pipe prior to assembly;

FIG. 15 is a planar cross-sectional view of the clip and the inner flow pipe after assembly;

FIG. 16 is a planar cross-sectional view of the clip and the inner flow pipe assembly prior to insertion into the solar tube end fitting;

FIG. 17 is a planar cross-sectional view of the clip and the inner flow pipe assembly after insertion into the solar tube end fitting;

FIG. 18 is an exploded view of the clip and the end region of the outer flow pipe;

FIG. 19 is a view of the end region of the outer flow pipe with the clip in place; and

FIG. 20 is an enlarged view of a corner detail of the assembly of FIG. 19.

### DETAILED DESCRIPTION

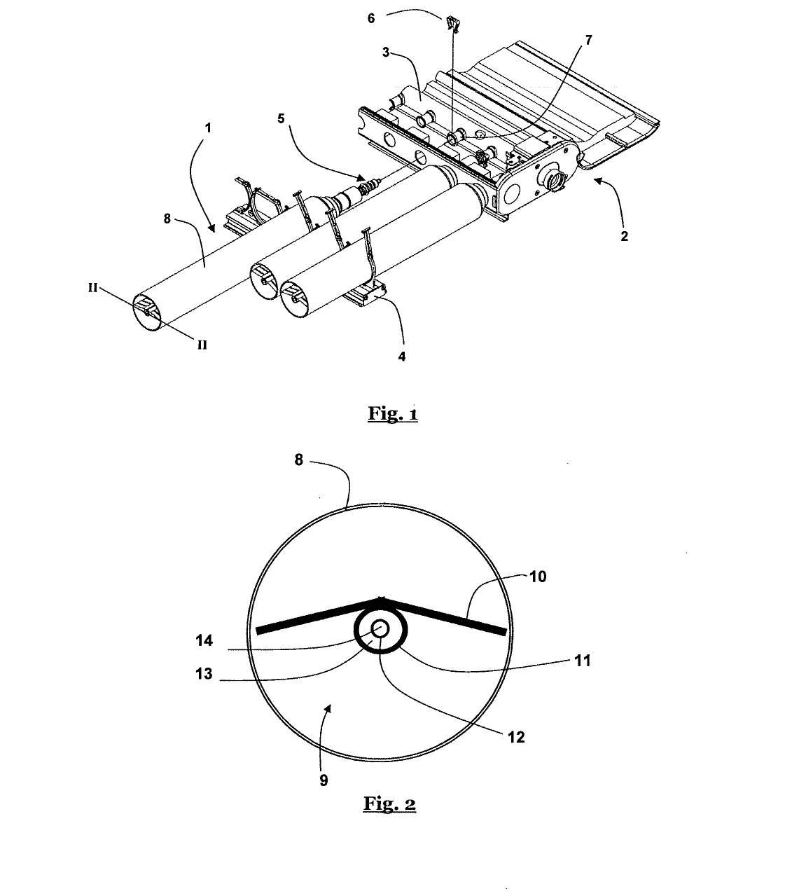

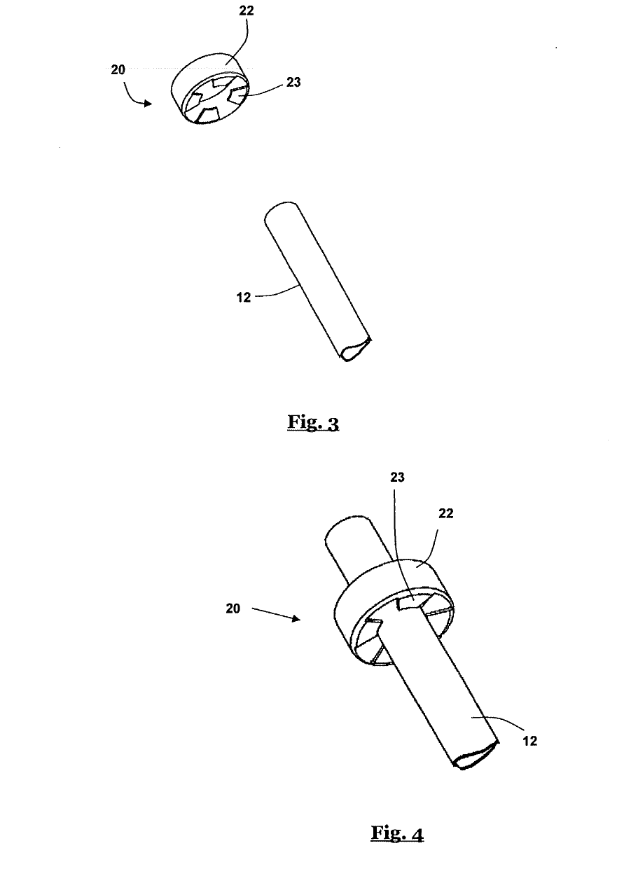

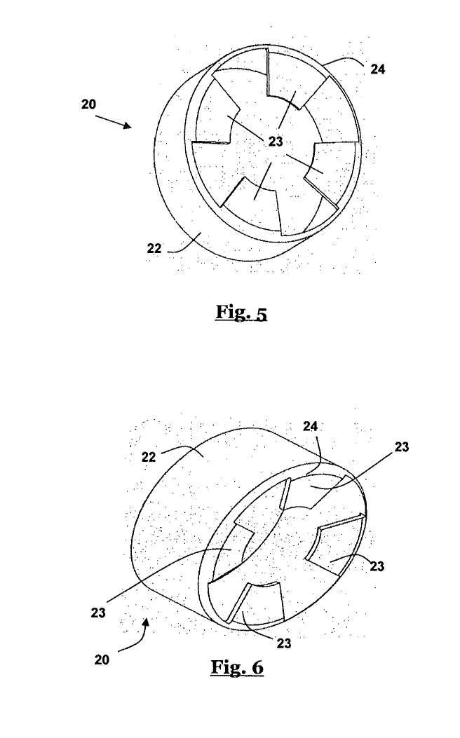

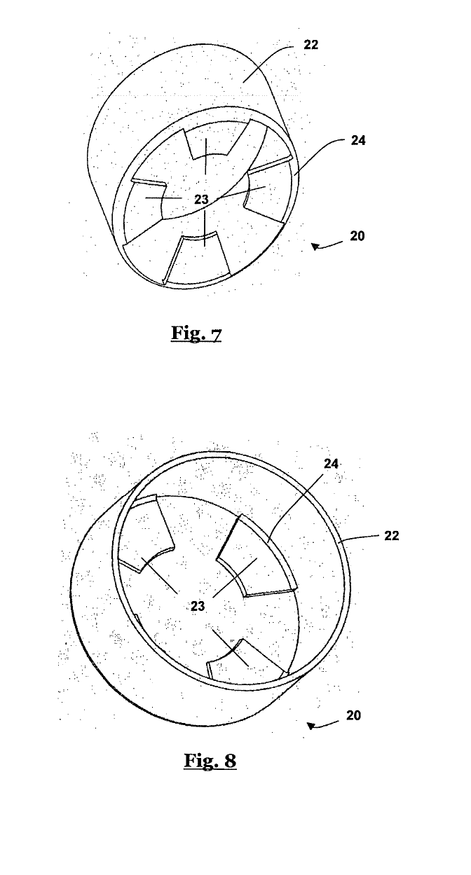

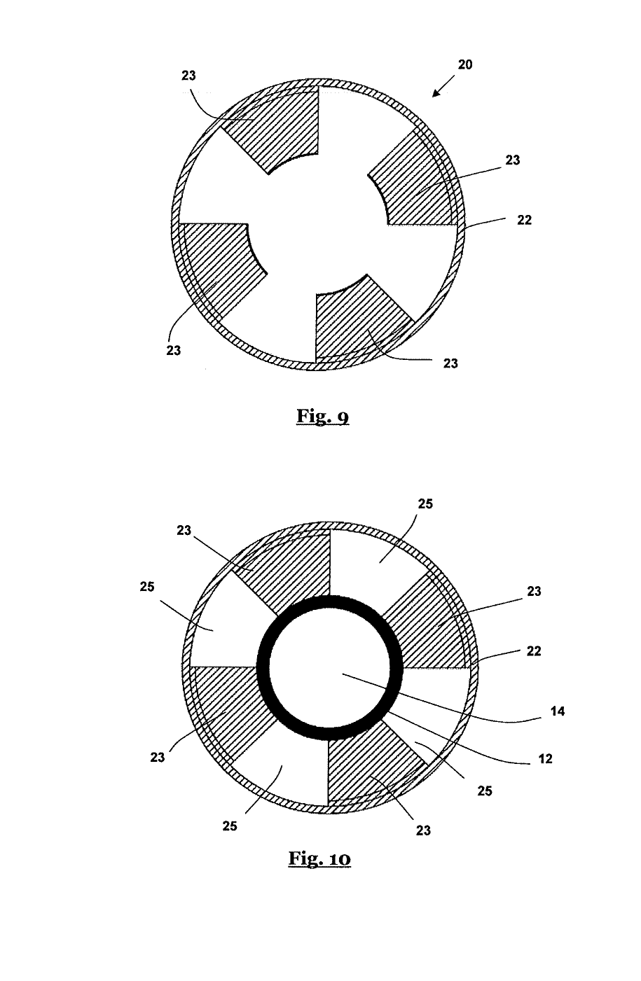

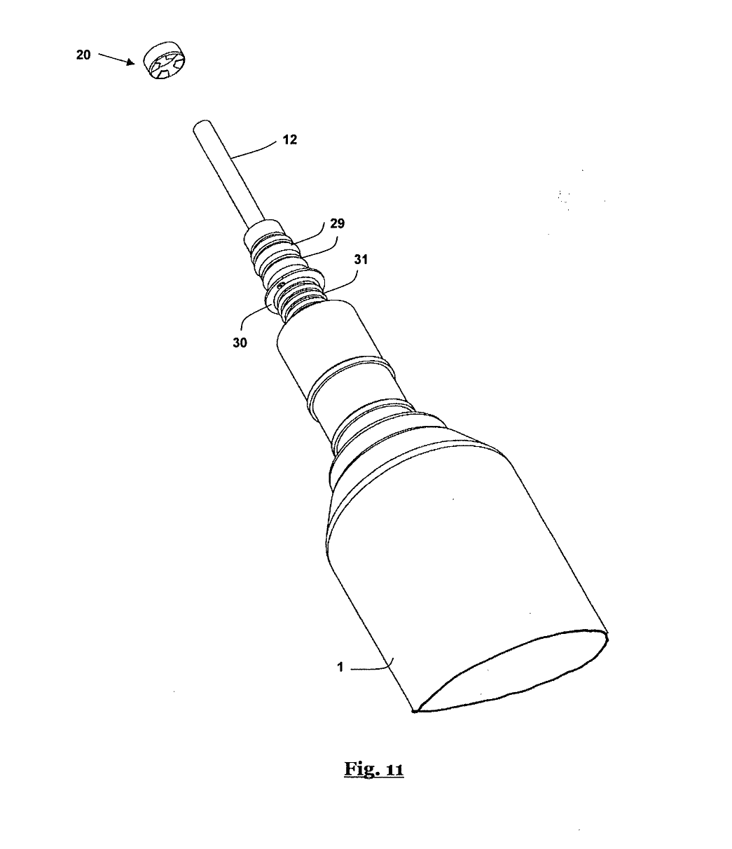

As illustrated in FIG. 1 a solar collector assembly of the direct flow type comprises a solar absorbing tube 1 comprising an evacuated radiation transparent enclosure 8 enclosing an absorbing section 9, comprising a radiation absorbing plate 10 for absorbing solar radiation and an elongate tube 11, containing a working fluid (heat transfer medium), in thermal contact with the radiation absorbing plate 10. The elongate tube 11 contains a concentrically positioned inner pipe 12 thereby forming two concentric internal flow passageways 13, 14 for the flow of a fluid to be heated. The elongate tube 11 extends out of one end of the solar absorbing tube 1 and into an end fitting 5 wherein an annular outer passageway 13 of the elongate tube 11 communicates with a cold water inlet stream within a manifold chamber 3 of a manifold 2 and the inner passageway 14 of the elongate tube 11 communicates with a hot water outlet stream within the manifold chamber 3, the water passing from the annular outer passageway 13 to the inner passageway 14 via a flow path provided at a distal end of the elongate tube 11. The end fitting 5 is inserted into a manifold flange 7 in order to facilitate the communication of the annular outer passageway 13 and the inner passageway 14 with the cold water inlet stream and the hot water outlet stream respectively, within the manifold chamber 3 of a manifold 2. A resilient clip 6 is used to secure the tube into its fitted position and to maintain the tube in its fitted position under operational conditions.

The inner conduit 12 extends beyond the end fitting 5 of the outer conduit 11 into the heated fluid passageway of the manifold 2. A clip 20 for retaining the inner conduit 12 in spaced-apart relation to the end fitting 5 of the outer conduit 11 comprises a generally circular base 24 which engages with the inner surface of the end fitting 5 of the outer conduit 11. The base 24 has a plurality of inwardly extending equi-spaced teeth 23 which engage with the outer wall of the inner conduit 12. The equi-spaced teeth 23 are at least partially resilient and are spaced-apart to allow heat exchange fluid to pass between the equi-spaced teeth 23. The equi-spaced teeth 23 are inclined inwardly with respect to circumference of the base 24.

In a particularly preferred embodiment the circular base 24 has a longitudinally extending outer wall 22. The outer wall 22 is preferably of generally cylindrical shape. The equi-spaced teeth 23 extend inwardly at one end of the outer wall 22.

Preferably there are at least three equi-spaced teeth 23. In this case there are four equi-spaced-apart teeth 23. The thickness of at least some of the equi-spaced teeth 23 is reduced at the inner free end thereof. The clip may be of stainless steel material.

The clip 20 is attached onto the inner conduit 12 and held in position by an interference fit between the equi-spaced teeth 23 and the outer surface of the inner conduit 12. The equi-spaced teeth 23 of the clip 20 are angled in a preferred direction to facilitate easy assembly in a preferred direction but resistance against removal in either direction.

The assembly consisting of the clip 20 attached to the inner conduit 12 is inserted into the outer conduit 11 and the resilient clip 20 rests upon an internal circumferential protrusion 41 on the internal surface of a one-piece flexible bellow assembly 31. The clip 20 holds the inner conduit 12 in a concentric position and ensures that the distal end of the inner conduit 12 does not come into contact with the distal end of the outer conduit 11 thereby ensuring a flow of the heating fluid.

The cyclindrical wall 22 of the clip 20 provides a strengthening circumferential base that forms a support structure around the outer diameter of the clip 20. The clip 20 is further provided with a plurality of engagement tags or teeth 23 that create an interference fit with the inner conduit 12 when it is pressed over the inner conduit 12.

The equi-spaced teeth 23 are designed such that they are folded to generate an inner circular clearance whose dimensional size is less in diameter that the outer diameter of the inner conduit 12 onto which the clip 20 is attached. The clip 20 is secured on to the inner conduit 12 by an interference between the equi-spaced teeth 23 and the inner conduit 12. When the clip 20 is attached to the inner conduit 12 the occlusions 25 in the clip 20 provide fluid conduits to allow the passage of the thermal fluid and facilitates communication with the annular outer passageway 13 with the cold fluid passageway of the manifold chamber 3. The concentrically positioned inner conduit 12 facilitates communication of the annular inner passageway 14 with the hot fluid passageway of the manifold chamber 3.

The clip 20 is positioned at a defined distance from the end of the inner conduit 12 to ensure that the annular inner passageway 14 communicates with an inner annular flow conduit in the manifold chamber 3 and the annular outer passageway 13 communicates with an outer flow conduit in the manifold chamber 3.

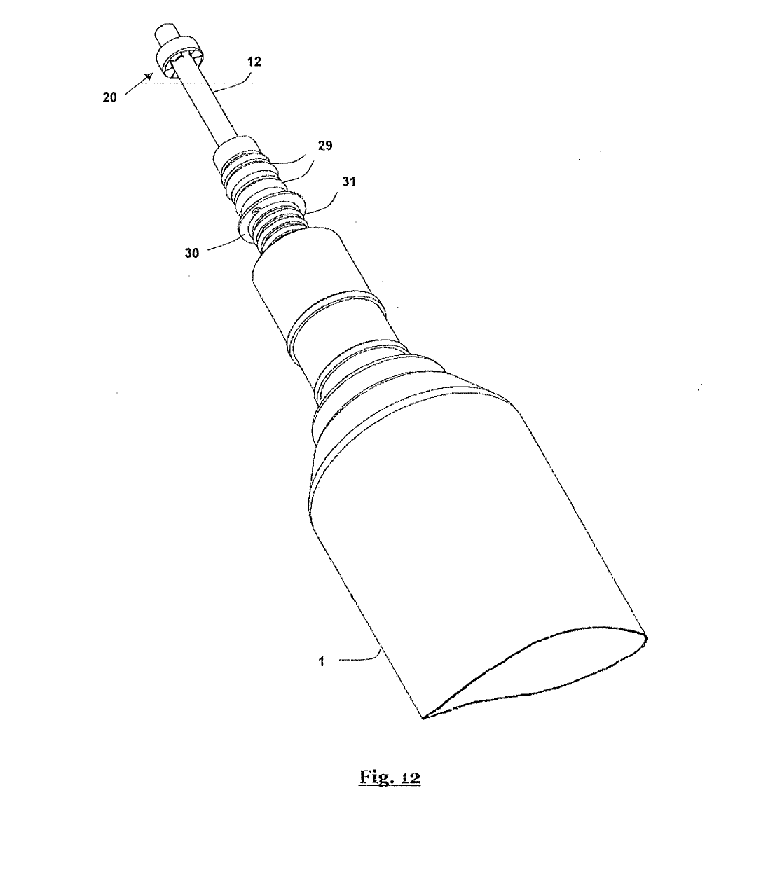

FIG. 11 to FIG. 13 are perspective views of the end fitting of a solar absorbing tube 1 of the direct flow type illustrating a preferred method of assembly using the resilient clip 20.

The end fitting 5 of a solar absorbing tube 1 if the direct flow type in a preferred embodiment comprises a one-piece flexible bellow assembly 31, a resilient retaining clip 30 and a plurality of o-ring seals 29 located in the convolutions of the flexible bellow assembly 31.

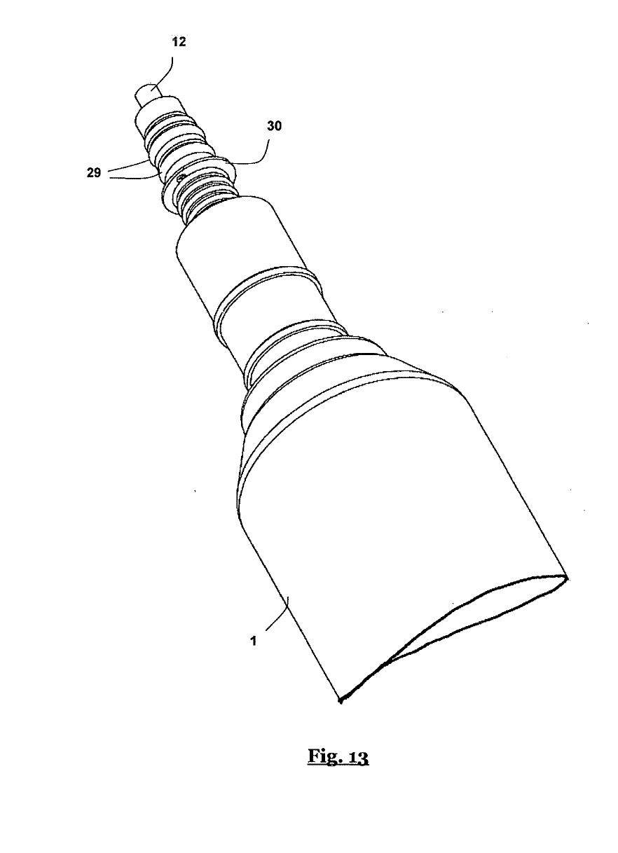

FIG. 11 is an exploded perspective view of the clip 20 and the solar tube end fitting 5 prior to assembly. FIG. 12 shows the clip 20 attached to the inner conduit 12. FIG. 13 shows the assembly of the clip 20 and the inner conduit 12 when fully assembled into the solar tube end fitting 5.

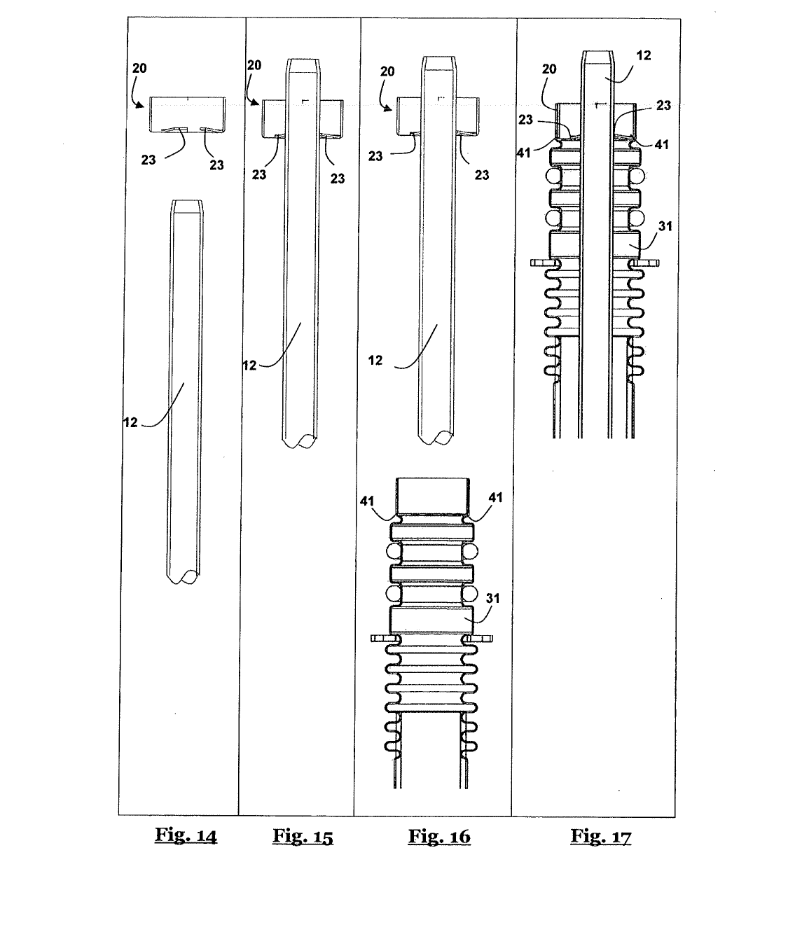

FIG. 14 to FIG. 17 illustrate the assembly of the clip 20 to the inner conduit 12 and insertion into the solar tube end fitting 5 in cross-sectional planar view. FIG. 14 shows the clip 20 and the inner conduit 12 prior to assembly. The equi-spaced teeth 23 of the clip 20 are angled to facilitate easy attachment to the inner conduit 12.

FIG. 15 illustrates the engagement of the clip 20 to the inner conduit 12. The equi-spaced teeth 23 generate an interference fit between the clip 20 and the inner conduit 12, and the angled equi-spaced teeth 23 serve to ensure a firm engagement between the clip 20 and the inner conduit 12.

FIG. 16 illustrates the clip 20 and inner conduit 12 assembly prior to insertion into the solar tube end fitting 5. The solar tube end fitting 5 is provided with a flexible bellow assembly 31 that has an internal circumferential protrusion 41 upon which the clip 20 engages when in its fully home position as illustrated in FIG. 17.

The clip 20 and inner conduit 12 assembly are inserted concentrically into the flexible bellow assembly 31 on the solar tube end fitting 5.

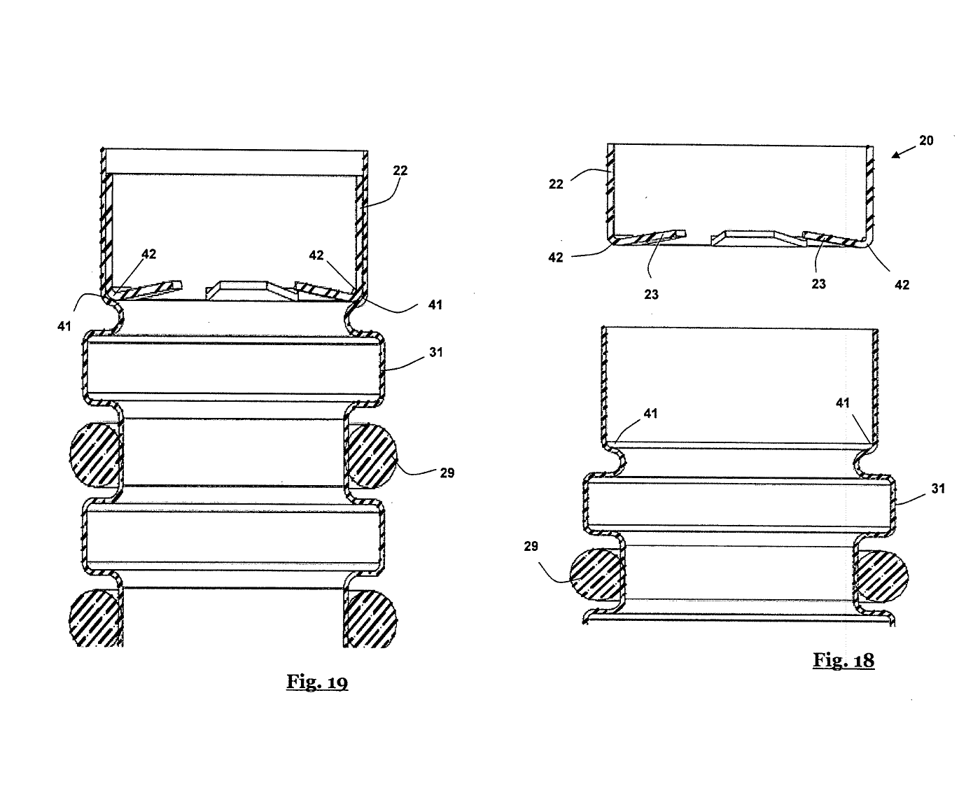

FIGS. 18 to 20 illustrate the assembly without the conduit 12 in place. FIG. 18 illustrates the clip 20 prior to insertion into the end fitting 5.

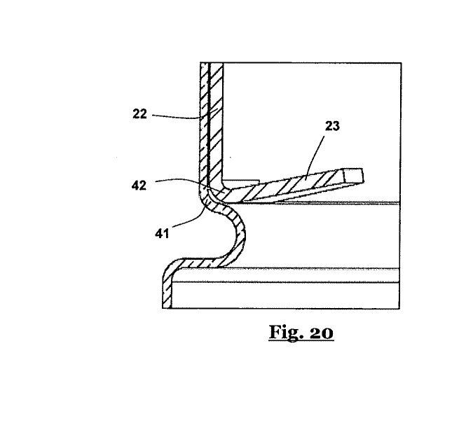

FIGS. 19 and 20 illustrates the finished assembly and the clip 20 resting in its final position by engaging with the internal circumferential protrusion 41 of the flexible bellow assembly 31. The circumferential edge 42 engages circumferentially with the internal circumferential protrusion 41 of the flexible bellow assembly 31. Additionally the extended side wall of the clip 20 circumferentially engage with the inner wall of the flexible bellow assembly 31 to provide additional rigidity and robustness to the flexible bellow assembly 31 in order to minimise damages to the flexible bellow assembly 31 during system installation.

The base of the clip engages with the inner surface of the end region of the outer conduit to ensure that any movement of the inner pipe in the longitudinal direction is prevented.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiments.

The invention is not limited to the embodiment hereinbefore described, with reference to the accompanying drawings, which may be varied in construction and detail.

1-20. (canceled)

21. A solar collector assembly comprising:
a solar absorbing tube having an evacuated radiation-transparent enclosure;
a radiation absorber within the tube;
an elongate outer conduit for a heat transfer medium extending through the tube and being in thermal contact with the radiation absorber;
an inner conduit extending through the outer conduit and being positioned within the outer elongate conduit to define an elongate internal flow passage for the flow of heat transfer medium;
a manifold having a heated fluid passageway and a cold fluid passageway;
the outer conduit having an end region extending into the manifold so that the passageway defined between the outer conduit and the inner conduit is in fluid communication with the cold fluid passageway of the manifold;
the inner conduit extending beyond the end region of the outer conduit into the heated fluid passageway of the manifold; and
a clip for retaining the inner conduit in spaced-apart relation to the end region of the outer conduit, the clip comprising a generally circular base which engages with the inner surface of the end region of the outer conduit, the base having a plurality of inwardly extending teeth which engage with the outer wall of the inner conduit, the teeth being at least partially resilient and being spaced-apart to allow heat exchange fluid to pass between the teeth.

22. The solar collector assembly as claimed in claim 21 wherein the teeth are inclined inwardly with respect to circumference of the base.

23. The solar collector assembly as claimed in claim 21 wherein the base has a longitudinally extending outer wall.

24. The solar collector assembly as claimed in claim 23 wherein the outer wall is of generally cylindrical shape.

25. The solar collector assembly as claimed in claim 23 wherein the teeth extend inwardly at one end of the outer wall.

26. The solar collector assembly as claimed in claim 21 comprising three equi-spaced-apart teeth.

27. The solar collector assembly as claimed in claim 21 comprising four equi-spaced-apart teeth.

28. The solar collector as claimed in claim 21 wherein the thickness of at least some of the teeth is reduced at the inner free end thereof.

29. The solar collector assembly as claimed in claim 21 wherein the clip is of stainless steel material.

30. A solar collector clip for retaining the inner conduit in spaced-apart relation to the end region of the outer conduit, the clip comprising a generally circular base which engages with the inner surface of the end region of the outer conduit, the base having a plurality of inwardly extending teeth which engage with the outer wall of the inner conduit, the teeth being at least partially resilient and being spaced-apart to allow heat exchange fluid to pass between the teeth.

31. The solar collector clip as claimed in claim 30 wherein the teeth are inclined inwardly with respect to circumference of the base.

32. The solar collector clip as claimed in claim 30 wherein the base has a longitudinally extending outer wall.

33. The solar collector clip as claimed in claim 32 wherein the outer wall is of generally cylindrical shape.

34. The solar collector clip as claimed in claim 32 wherein the teeth extend inwardly at one end of the outer wall.

35. The solar collector clip as claimed in claim 30 comprising three equi-spaced-apart teeth.

36. The solar collector clip as claimed in claim 30 comprising four equi-spaced-apart teeth.

37. The solar collector clip as claimed in claim 30 wherein the thickness of at least some of the teeth is reduced at the inner free end thereof.

38. The solar collector clip as claimed in claim 30 wherein the clip is of stainless steel material.
